(19) United States
(12) Patent Application Publication
(10) Pub. No.: US 2015/0373126 A1
(43) Pub. Date: Dec. 24, 2015

(54) METHOD, APPARATUS AND SYSTEM FOR INTERACTIVE DATA EXCHANGE

(71) Applicant: TENCENT TECHNOLOGY (SHENZHEN) COMPANY LIMITED, Shenzhen (CN)

(72) Inventor: Tongxing Ma, Shenzhen (CN)

(73) Assignee: TENCENT TECHNOLOGY (SHENZHEN) COMPANY LIMITED, Shenzhen (CN)

(21) Appl. No.: 14/839,343

(22) Filed: Aug. 28, 2015

Related U.S. Application Data
(63) Continuation of application No. PCT/CN2014/074624, filed on Apr. 2, 2014.

(30) Foreign Application Priority Data
Apr. 26, 2013 (CN) 201310150244.3

(51) Int. Cl. H04L 29/08

(52) U.S. Cl. CPC H04L 67/141; H04L 67/1002

(57) ABSTRACT

A method, apparatus and system for exchanging data, the method including: receiving an identifier of a data server to exchange data with a mobile terminal; determining the data server in accordance with the identifier of the data server; and relaying data to be exchanged between the mobile terminal and the data server. The mobile terminal exchanges data with the data server originally configured to support landline terminals through the access server, which enhances data exchange between the mobile terminal and the data server.

### CROSS-REFERENCE TO RELATED APPLICATIONS

This application is a continuation of International Patent Application No. PCT/CN2014/074624, entitled “Method, Apparatus and System for Interactive Data Exchange,” filed on Apr. 2, 2014. This application claims the benefit and priority of Chinese Patent Application No. 201310150244.3, entitled “Method, Apparatus and System for Interactive Data Exchange,” filed on Apr. 26, 2013. The entire disclosures of each of the above applications are incorporated herein by reference.

### TECHNICAL FIELD

The present invention relates to communication technology, and more particularly, to a method, apparatus and system for interactive data exchange.

### BACKGROUND

With the development of mobile internet, more and more traditional internet services have been extended to mobile terminals. For example, mobile terminals now can be used to both play online games and shop online. However, when a mobile terminal connects to a data server designed for landline users, the connection quality is often low, with a high rate of disconnection.

To address the technical issues of low connection quality and high disconnection rate for mobile terminals, some network operators deploy dedicated servers for mobile terminals so that mobile terminals can exchange data with the dedicated servers with better connection quality.

However, the network operators can only deploy limited number of dedicated servers for mobile terminals. In addition, the dedicated servers can only host limited amount of data, and the mobile users can only exchange data with the dedicated servers, which limits the scope of data exchange for mobile internet users. Moreover, if the mobile terminal establishes a direct connection with the data server across different operator networks, significant delay and technical issue often occurs.

### SUMMARY OF THE INVENTION

The embodiments of the present invention provide method, apparatus and system for interactive data exchange, wherein the mobile terminal exchanges data with server originally configured to support landline terminals.

The embodiments of the present invention provides a method for exchanging data, comprising: receiving an identifier of a data server to exchange data with a mobile terminal; determining the data server in accordance with the identifier of the data server; and relaying data to be exchanged between the mobile terminal and the data server.

In accordance with one embodiment of the present invention, the present invention provides a method for exchanging data, comprising: receiving data sent by a mobile terminal through relaying of an access server; determining data to be returned to the mobile terminal in accordance with the data sent by the mobile terminal; and sending the data to be returned to the mobile terminal to the access server.

The present invention also provides an access server, comprising: a first receiving unit configured to receive an identifier of a data server to exchange data with a mobile terminal; a first determination unit configured to determine the data server in accordance with the identifier of the data server received by the first receiving unit; and a first transmitting unit configured to relay data to be exchanged between the mobile terminal and the data server.

The present invention also provides a data server, comprising: a second receiving unit configured to receive data sent by a mobile terminal through relaying of an access server; a second determination unit configured to determine data to be returned to the mobile terminal in accordance with the data sent by the mobile terminal; and a second transmitting unit configured to send the data to be returned to the mobile terminal to the access server.

In accordance with the embodiment of the present invention, the mobile terminal sends the identifier of a data server to exchange data to an access server, and the access server determines the data server in accordance with the identifier, and relays data to be exchanged between the mobile terminal and the data server. The mobile terminal can exchange data with server originally configured to support landline terminals through the access server, which enhances data exchange between the mobile terminal and the data server. In addition, there is no need to deploy dedicated servers for mobile terminals, which simplifies the networking configuration. Furthermore, since there is no need to establish direct connection across different operator networks, the quality of data exchange is enhanced.

### BRIEF DESCRIPTION OF THE DRAWINGS

To better illustrate the technical features of the embodiments of the present invention, various embodiments of the present invention will be briefly described in conjunction with the accompanying drawings. It should be understood that the drawings below are merely for some exemplary embodiments of the present invention, and for those skilled in the art, other drawings can be obtained based on these drawings.

FIG. 1 is an exemplary diagram for a method for exchanging data in accordance with an embodiment of the present invention.

FIG. 2 is an exemplary diagram for a method for exchanging data in accordance with another embodiment of the present invention.

FIG. 3 is an exemplary diagram for an access server for exchanging data in accordance with an embodiment of the present invention;

FIG. 4 is an exemplary diagram for an access server for exchanging data in accordance with another embodiment of the present invention;

FIG. 5 is an exemplary diagram for a data server for exchanging data in accordance with an embodiment of the present invention;

FIG. 6 is an exemplary diagram for a system for exchanging data in accordance with an embodiment of the present invention.

### DESCRIPTION OF THE PREFERRED EMBODIMENTS

The embodiments of the present invention provide method for interactive data exchange, wherein the mobile terminal can exchange data with server originally configured to support landline terminals. The embodiments of the present invention also provide corresponding apparatus and system for data exchange. The present invention will be illustrated in details through the following embodiments.

To better illustrate the purpose, technical feature, and advantages of the embodiments of the present invention, various embodiments of the present invention will be further described in conjunction with the accompanying drawings. It should be understood that not all the embodiments are included here, and all the embodiments that could be made by those skilled in the art based on these embodiments are within the scope of the present invention.

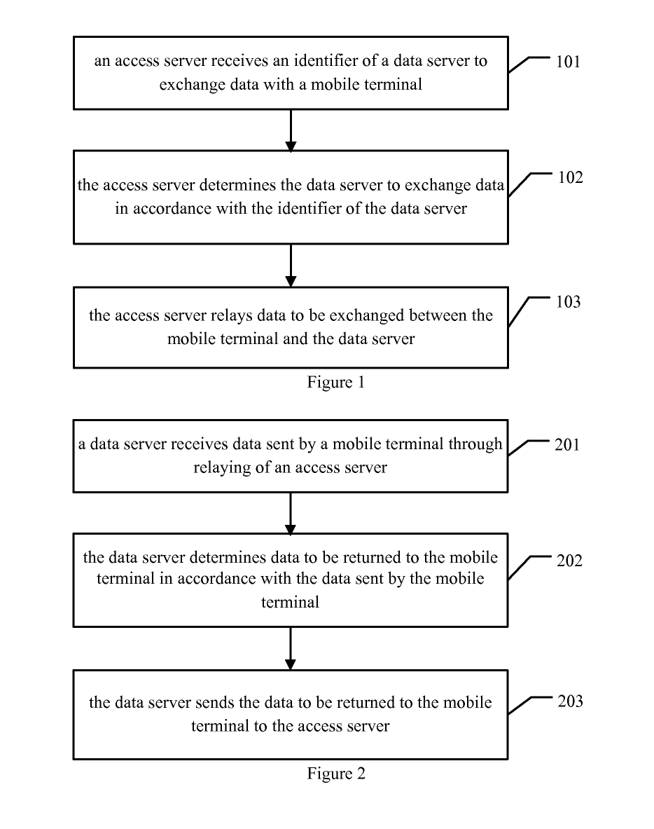

FIG. 1 is an exemplary diagram for a method for exchanging data in accordance with an embodiment of the present invention. As shown in FIG. 1, the method for exchanging data includes the following steps.

Step 101: an access server receives an identifier of a data server to exchange data with a mobile terminal.

When a user plays online game using a mobile terminal, the mobile terminal generally is connected to a data server originally configured to support landline terminals, such as personal computers (PC). Since the connection quality is low with high disconnection rate when the mobile terminal is directly connected to a data server originally configured to support landline terminals, in this embodiment of the present invention, the mobile terminal is connected to the data server through an access server.

Since the access server is always connected to the data server, the mobile terminal only needs to establish connection to the access server.

Once the access server receives the identifier of the data server to exchange data sent by the mobile terminal, it can determine which server the data will be relayed to.

Step 102: the access server determines the data server to exchange data in accordance with the identifier of the data server.

There can be more than one identifier of the data server stored in the access server. After receiving an identifier of a data server, the access server can determine which server the data from the mobile terminal will be sent to.

Step 103: the access server relays data to be exchanged between the mobile terminal and the data server.

Once the access server determines which server the data will be sent to, it will relay the data between the mobile terminal and the data server until the mobile terminal sends the identifier of another data server, or disconnect the connection.

In accordance with this embodiment of the present invention, the mobile terminal sends the identifier of a data server to exchange data to an access server, and the access server determines the data server in accordance with the identifier, and relays data to be exchanged between the mobile terminal and the data server. The mobile terminal can exchange data with server originally configured to support landline terminals through the access server, which enhances data exchange between the mobile terminal and the data server. In addition, there is no need to deploy dedicated servers for mobile terminals, which simplifies the networking configuration.

Alternatively, in accordance with another embodiment of the present invention based on the embodiment in FIG. 1, the method for exchanging data, prior to the step of receiving an identifier of a data server to exchange data with a mobile terminal, further comprises: receiving a connection request sent by the mobile terminal; authenticating the mobile terminal; if the mobile terminal is authenticated, establishing connection with the mobile terminal.

In this embodiment of the present invention, the access server can authenticate the mobile terminal when the mobile terminal requests access. The access server provides access to the mobile terminal only if the mobile terminal is authenticated.

Alternatively, in accordance with another embodiment of the present invention based on the embodiment in FIG. 1, the method for exchanging data further comprises: sending an identifier of the mobile terminal to the data server, the data server selecting data to be returned to the mobile terminal in accordance with the identifier of the mobile terminal.

In this embodiment of the present invention, since the screen of the mobile is small and the bandwidth is limited, it is likely that only part of the data requested by the mobile terminal is useful, and the other part of the date could be filtered by the data server. After the data server receives the identifier of the mobile terminal sent by the access server, the data server will select the data to be returned to the mobile terminal in accordance with a preset scheme of providing data for the mobile terminal, and determine the select data to be returned to the mobile terminal.

For example, in playing a typical online mahjong game, a PC commonly will display four hands of cards in the desktop. When the mahjong game is played on a mobile terminal, only one hand of cards needs to be displayed. Thus, the user of mobile terminal can play games with PC users, and data sent to the mobile terminals are selected in accordance with its characteristic of small screen and limited bandwidth, which enhances the experience of the user.

FIG. 2 is an exemplary diagram for a method for exchanging data in accordance with another embodiment of the present invention. The method for exchanging data includes the following steps.

Step 201: a data server receives data sent by a mobile terminal through relaying of an access server.

Step 202: the data server determines data to be returned to the mobile terminal in accordance with the data sent by the mobile terminal.

Step 203: the data server sends the data to be returned to the mobile terminal to the access server.

The mobile terminal needs to be authenticated before it accesses the access server.

In accordance with this embodiment of the present invention, the mobile terminal sends the identifier of a data server to exchange data to an access server, and the access server determines the data server in accordance with the identifier, and relays data to be exchanged between the mobile terminal and the data server. The mobile terminal can exchange data with server originally configured to support landline terminals through the access server, which enhances data exchange between the mobile terminal and the data server. In addition, there is no need to deploy dedicated servers for mobile terminals, which simplifies the networking configuration.

Alternatively, in accordance with one embodiment of the present invention based on the embodiment in FIG. 2, the method for exchanging data further comprises: receiving an identifier of the mobile terminal sent by the access server; and wherein the step of determining data to be returned to the mobile terminal comprises selecting data to be returned to the mobile terminal in accordance with the identifier of the mobile terminal to generate select data to be returned to the mobile terminal; and the step of sending the data to be returned to the mobile terminal to the access server comprises sending the select data to be returned to the mobile terminal to the access server.

In this embodiment of the present invention, since the screen of the mobile is small and the bandwidth is limited, it is likely that only part of the data requested by the mobile terminal is useful, and the other part of the date could be filtered by the data server. After the data server receives the identifier of the mobile terminal sent by the access server, the data server will select the data to be returned to the mobile terminal in accordance with a preset scheme of providing data for the mobile terminal, and determine the select data to be returned to the mobile terminal.

For example, in playing a typical online mahjong game, a PC commonly will display four hands of cards in the desktop. When the mahjong game is played on a mobile terminal, only one hand of cards needs to be displayed. Thus, the user of mobile terminal can play games with PC users, and data sent to the mobile terminals are selected in accordance with its characteristic of small screen and limited bandwidth, which enhances the experience of the user.

The data exchange among a mobile terminal, an access server and a data server is further described in the following scenarios.

S100: the mobile terminal sends a connection request to the access server.

The game program installed in the mobile terminal is associated with the data server of the game program. If the user starts the game program on the mobile terminal, the connection request will automatically include the game server.

S105: the access server authenticates the mobile terminal, and if the mobile terminal is authenticated, establishes connection with the mobile terminal.

S110: the access server receives an identifier of the data server sent by the mobile terminal.

S115: the access server determines the data server to exchange data in accordance with the identifier of the data server.

S120: the access server relays data to be exchanged between the mobile terminal and the data server.

The data server also can filter the data requested by the mobile terminal, and send select data to the mobile terminal to the access server to limit the data traffic with the mobile terminal.

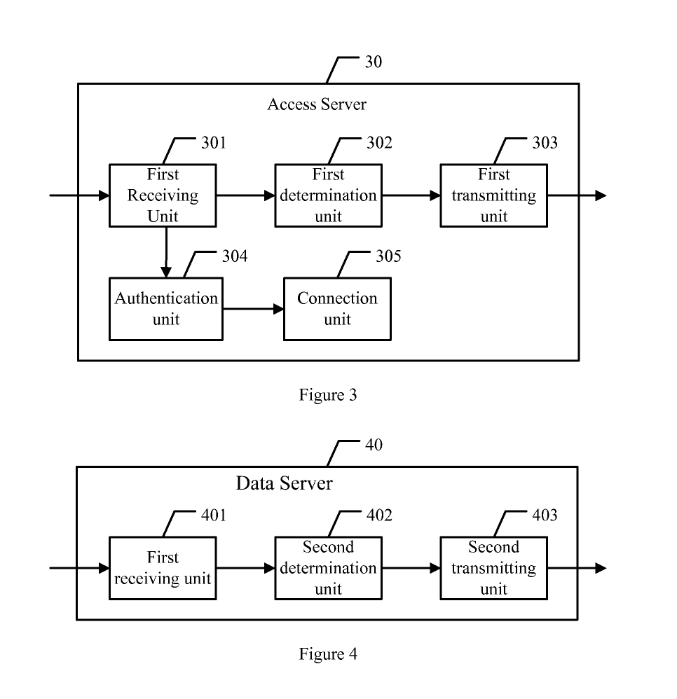

FIG. 3 is an exemplary diagram for an access server for exchanging data in accordance with an embodiment of the present invention. The access server includes a first receiving unit 301 configured to receive an identifier of a data server to exchange data with a mobile terminal; a first determination unit 302 configured to determine the data server in accordance with the identifier of the data server received by the first receiving unit; and a first transmitting unit 303 configured to relay data to be exchanged between the mobile terminal and the data server.

In accordance with this embodiment of the present invention, the mobile terminal sends the identifier of the data server to exchange data to the first receiving unit 301, the first determination unit 302 determines the data server in accordance with the identifier, and the first transmitting unit 303 relays data to be exchanged between the mobile terminal and the data server. The mobile terminal can exchange data with server originally configured to support landline terminals through the access server, which enhances data exchange between the mobile terminal and the data server. In addition, there is no need to deploy dedicated servers for mobile terminals, which simplifies the networking configuration.

In another embodiment, the access server further includes: an authentication unit 304 configured to authenticate the mobile terminal; and a connection unit 305 configured to, if the mobile terminal is authenticated, establish connection with the mobile terminal.

The first receiving unit 301 is further configured to receive a connection request sent by the mobile terminal.

In another embodiment, the first transmitting unit 303 is further configured to send an identifier of the mobile terminal to the access server, and the data server is configured to select data to be returned to the mobile terminal in accordance with the identifier of the mobile terminal.

FIG. 4 is an exemplary diagram for a data server for exchanging data in accordance with an embodiment of the present invention. The data server includes a second receiving unit 401 configured to receive data sent by a mobile terminal through relaying of an access server; a second determination unit 402 configured to determine data to be returned to the mobile terminal in accordance with the data sent by the mobile terminal; and a second transmitting unit 403 configured to send the data to be returned to the mobile terminal to the access server.

In accordance with this embodiment of the present invention, the mobile terminal sends data to the second receiving module 401 through relaying of the access server, the second determination unit 402 determines the data to be returned to the mobile terminal in accordance with the data sent by the mobile terminal, and the second transmitting unit sends the data to be returned to the mobile terminal to the access server. The mobile terminal can exchange data with server originally configured to support landline terminals through the access server, which enhances data exchange between the mobile terminal and the data server. In addition, there is no need to deploy dedicated servers for mobile terminals, which simplifies the networking configuration.

Alternatively, in accordance with another embodiment of the present invention based on the embodiment in FIG. 4, the second receiving unit 401 is further configured to receive an identifier of the mobile terminal sent by the access server; the second determination unit 402 is configured to select data to be returned to the mobile terminal in accordance with the identifier of the mobile terminal to generate select data to be returned to the mobile terminal; and the second transmitting unit 403 is configured to send the select data to be returned to the mobile terminal to the access server.

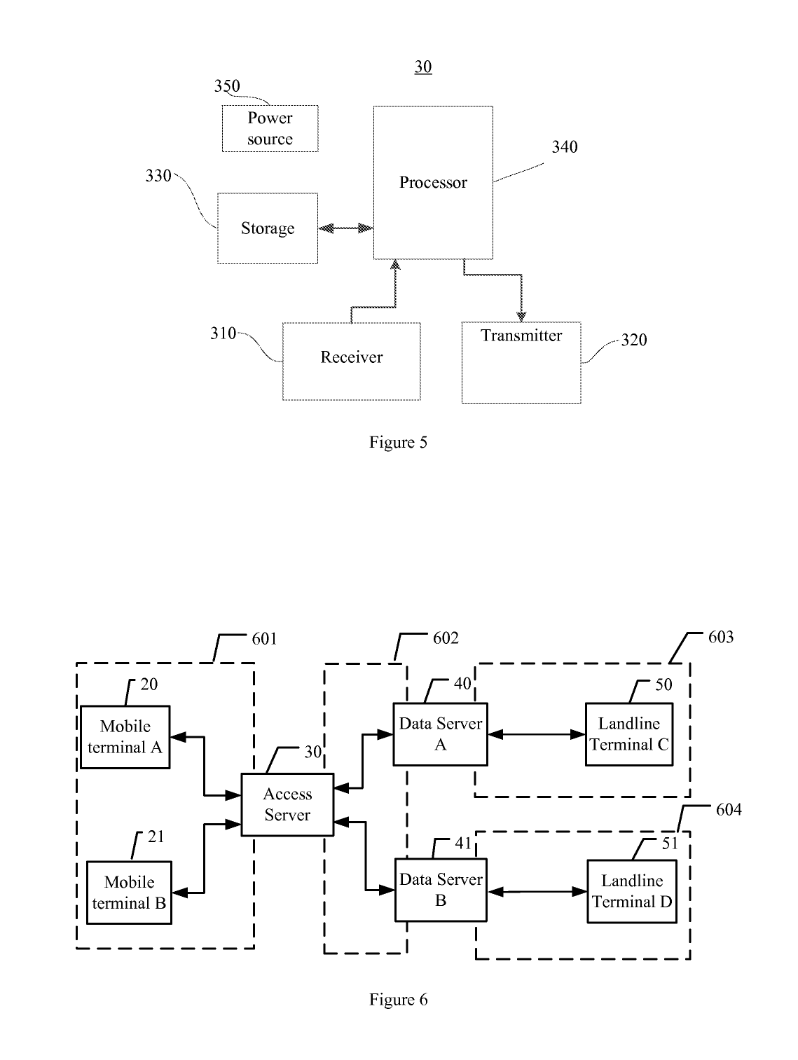

FIG. 5 is an exemplary diagram for an access server for exchanging data in accordance with another embodiment of the present invention. The access server 30 includes a receiver 310, a transmitter 320, a storage 330 and a processor 340, wherein the receiver 310, the transmitter 320, the storage 330 and the processor 340 are connected, such as by bus or other means.

The first storage 330 includes one or more computer readable storage mediums. There can be one or more processors 340. The access server 30 also can include a power supply. Those skilled in the art that will understand that the access server is not limited to the components illustrated in FIG. 5, but can include more or less than the components illustrated in FIG. 5.

The storage 330 is configured for storing software and module; the processor 340 is configured for carrying out the application functions and the data exchange by running the software and module stored in the storage 330. The storage 330 mainly includes a program storage area and a data storage area, wherein the operating system and at least one application are stored in the program storage area. In addition, the storage 330 can include a high speed random access memory (RAM), and/or a non-volatile memory (NVRAM), such as a disk storage device, a flash memory device, or other non-volatile solid-state memory device. Accordingly, the storage 330 also can include a storage controller configured to provide access to the storage 330 by the processor 340 and the receiver 310.

The processor 340 is the control center of the access server 30, and connects the parts of the access server 30 together via interfaces and circuits. The processor 340 carries out various functions of the access server and data exchange by executing the software programs and/or modules stored in the storage 330, and accessing the data stored in the storage 330. Alternatively, the processor 340 can include one or more processing cores; preferably, the processor 340 can integrate an application processor and a modulation and demodulation processor.

The access server 30 also includes a power source 350 (e.g., battery) to provide power to each part; preferably, the power source 350 can be logically connected with the processor 340 through a power source management system for charging, discharging, and power management. The power source 350 also can include one or more direct current or alternating current supply, power recharging system, detection circuit for power failure, power converter or power inverter, and power status indicator etc.

The receiver 310 is configured for receiving the identifier of the data server to exchange data sent by the mobile terminal, the processor 340 is configured for determining the data server in accordance with the identifier of the data server; and the transmitter 320 is configured for relaying data to be exchanged between the mobile terminal and the data server.

In accordance with another embodiment of the present invention, the receiver 310 is further configured for receiving a connection request sent by the mobile terminal; the processor 340 is further configured for authenticating the mobile terminal; and if the mobile terminal is authenticated, establishing connection with the mobile terminal.

In accordance with another embodiment of the present invention, the transmitter 320 is further configured for sending an identifier of the mobile terminal to the data server, the service serve selecting data to be returned to the mobile terminal in accordance with the identifier of the mobile terminal.

In accordance with another embodiment of the present invention, the receiver 310 is configured for receiving data sent by a mobile terminal through relaying of an access server; the processor 340 is configured for determining data to be returned to the mobile terminal in accordance with the data sent by the mobile terminal; and the transmitter 320 is configured for sending the data to be returned to the mobile terminal to the access server.

In accordance with another embodiment of the present invention, the receiver 310 is further configured to receive an identifier of the mobile terminal sent by the access server; the processor 340 is configured to select data to be returned to the mobile terminal in accordance with the identifier of the mobile terminal to generate select data to be returned to the mobile terminal; and the transmitter 320 is configured to send the select data to be returned to the mobile terminal to the access server.

FIG. 6 is an exemplary diagram for a system for exchanging data in accordance with an embodiment of the present invention. As shown in FIG. 6, the system comprises mobile terminals 20 and 21, an access server 30, data servers 40 and 41, and landline terminals 50 and 51.

The access server 30 is configured for receiving an identifier of a data server to exchange data with a mobile terminal; determining the data server in accordance with the identifier of the data server; and relaying data to be exchanged between the mobile terminal and the data server.

The data server 40 is configured for receiving data sent by a mobile terminal through relaying of an access server; determining data to be returned to the mobile terminal in accordance with the data sent by the mobile terminal; and sending the data to be returned to the mobile terminal to the access server. It is known to all those skilled in the art that all or part of the steps in the above mentioned embodiments can be achieved through instructing relevant hard wares by programs, and the programs can be stored in a computer readable storage medium such as a ROM, RAM, magnetic disk or CD-ROM etc.

As shown in FIG. 6, the system includes networks provided by different operators: network 601 is a mobile network provided by China mobile, network 602 is a private network provided by a gaming company, network 603 is a landline network provided by China Netcom, and network 604 is a landline network provided by China Telecomm.

The mobile terminal 20 in the China Mobile network can connect to data server 40 provided by China Netcom through the access server 30 provided by China Mobile, so that China Mobile user A can use the services provided by the China Netcom data server 40.

The mobile terminal 21 in the China Mobile network can connect to data server 41 provided by China Telecomm through the access server 30 provided by China Mobile, so that China Mobile user B can use the services provided by the China Telecomm data server 41.

The landline terminal 50 in the China Netcom network is directly connected to the data server 40 provided by China Netcom.

The landline terminal 51 in the China Telecomm network is directly connected to the data server 41 provided by China Netcom.

Here, mobile terminal 20 and landline terminal 51 share the services provided by data server 40 provide by China Netcom, and can interact with each other, such as in online games and chatting. Since no direct connection across different operator networks is needed, the quality of data exchange is enhanced.

Similarly, mobile terminal 21 and landline terminal 50 share the services provided by data server 41 by China Telecomm, and can and can interact with each other, such as in online games and chatting. Since no direct connection across different operator networks is needed, the quality of data exchange is enhanced.

As shown in FIG. 6, the access server 30 can connect the mobile terminals to more than one data server, which significantly improves operation efficiency. Specifically, a very limited number of access servers can be deployed to make the services of a large number of data servers available to all mobile terminals. For example, mobile terminal 20 can also connect to the data server 41 through the access server 30, and interact with landline terminal 50; mobile terminal 21 can also connect to the data server 40 through the access server 30, and interact with landline terminal 51; and mobile terminal 20 can also interact with mobile terminal 21 through the access server 30.

In accordance with this embodiment of the present invention, the mobile terminal sends the identifier of a data server to exchange data to an access server, and the access server determines the data server in accordance with the identifier and relays data to be exchanged between the mobile terminal and the data server. The mobile terminal can exchange data with server originally configured to support landline terminals through the access server, which enhances data exchange between the mobile terminal and the data server. In addition, there is no need to deploy dedicated servers for mobile terminals, which simplifies the networking configuration. Furthermore, since there is no need to establish direct connection across different operator networks, the quality of data exchange is enhanced.

The method, apparatus and system for exchanging data of the present invention have been illustrated in detail in the above mentioned embodiments. The various embodiments of the present invention are merely preferred embodiments, and are not intended to limit the scope of the present invention, which includes any modification, equivalent, or improvement that does not depart from the spirit and principles of the present invention.

1. A method for exchanging data, comprising:
establishing a first connection between an access server and a terminal;
receiving an identifier of a data server from the terminal through the first connection;
establishing a second connection between the access server and the data server in accordance with the identifier of the data server; and
relaying data received from the terminal through the first connection to the data server through the second connection.

2. The method of claim 1, further comprising:
relaying data received from the data server through the second connection to the terminal through the first connection.

3. The method of claim 1, wherein the first connection is established in a first operator's network.

4. The method of claim 1, wherein the second connection is established in a second operator's network.

5. The method of claim 1, wherein the first connection is wireless connection, and the terminal is a mobile terminal.

6. The method of claim 5, further comprising:
receiving data sent by the mobile terminal through relaying of the access server;
determining data to be returned to the mobile terminal in accordance with the data sent by the mobile terminal; and
sending the data to be returned to the mobile terminal to the access server.

7. The method of claim 6, further comprising:
receiving an identifier of the mobile terminal sent by the access server; and wherein
the step of determining data to be returned to the mobile terminal comprises selecting data to be returned to the mobile terminal in accordance with the identifier of the mobile terminal to generate select data to be returned to the mobile terminal; and
the step of sending the data to be returned to the mobile terminal to the access server comprises sending the select data to be returned to the mobile terminal to the access server.

8. An access server for exchanging data, comprising:
a first connection module configured to establish a first connection with a terminal;
a routing module configured to receive an identifier of a data server from the terminal through the first connection;
a second connection module configured to establish a second connection with the data server in accordance with the identifier of the data server; and
a relaying module configured to relay data received from the terminal through the first connection to the data server through the second connection.

9. The access server of claim 8, where the relay module is further configured for relaying data received from the data server through the first second connection to the terminal through the first connection.

10. The access server of claim 8, wherein the first connection is established in a first operator's network.

11. The access server of claim 8, wherein the second connection is established in a second operator's network.

12. The access server of claim 8, wherein first connection module comprises a wireless transmitter, the first connection is wireless connection, and the terminal is a mobile terminal.

13. The access server of claim 12, wherein the data server comprises:
a second receiving unit configured to receive data sent by the mobile terminal through relaying of the access server;
a second determination unit configured to determine data to be returned to the mobile terminal in accordance with the data sent by the mobile terminal; and
a second transmitting unit configured to send the data to be returned to the mobile terminal to the access server.

14. The access server of claim 13, wherein
the second receiving unit of the data server is further configured to receive an identifier of the mobile terminal sent by the access server;
the second determination unit of the data server is configured to select data to be returned to the mobile terminal in accordance with the identifier of the mobile terminal to generate select data to be returned to the mobile terminal; and
wherein the second transmitting unit of the data server is configured to send the select data to be returned to the mobile terminal to the access server.

15. An system for data access, comprising
a mobile terminal;
an access server, the access server comprising:
a first receiving unit configured to receive an identifier of a data server to exchange data with a mobile terminal;
a first determination unit configured to determine the data server in accordance with the identifier of the data server received by the first receiving unit; and
a first transmitting unit configured to relay data to be exchanged between the mobile terminal and the data server; and.
a data server, the data server comprising
a second receiving unit configured to receive data sent by a mobile terminal through relaying of an access server;
a second determination unit configured to determine data to be returned to the mobile terminal in accordance with the data sent by the mobile terminal; and
a second transmitting unit configured to send the data to be returned to the mobile terminal to the access server.

16. The system of claim 15, wherein the first acquisition unit is further configured to receive a connection request sent by the mobile terminal; and
the access server further comprises:
an authentication unit configured to authenticate the mobile terminal; and
a connection unit configured to, if the mobile terminal is authenticated, establish connection with the mobile terminal.

17. The system of claim 15, wherein the first sending unit is further configured to send an identifier of the mobile terminal to the access server, and the data data server is configured to select data to be returned to the mobile terminal in accordance with the identifier of the mobile terminal.

18. The system of claim 15, wherein
the second receiving unit is further configured to receive an identifier of the mobile terminal sent by the access server;
the second determination unit is configured to select data to be returned to the mobile terminal in accordance with the identifier of the mobile terminal to generate select data to be returned to the mobile terminal; and
wherein the second transmitting unit is configured to send the select data to be returned to the mobile terminal to the access server.
